(19) United States
(12) Patent Application Publication
(10) Pub. No.: US 2021/0356990 A1
(43) Pub. Date: Nov. 18, 2021

(54) OUTPUT DEVICE ORIENTATIONS ADJUSTMENTS

(71) Applicant: Hewlett-Packard Development Company, L.P., Spring, TX (US)

(72) Inventors: Dong Ryul Cha, Spring, TX (US); llchan Lee, Spring, TX (US)

(73) Assignee: Hewlett-Packard Development Company, L.P., Spring, TX (US)

(21) Appl. No.: 17/052,397

(22) PCT Filed: Feb. 4, 2019
(86) PCT No.: PCT/US2019/016457

§ 371 Date: Nov. 2, 2020

(51) Int. Cl. G06F 1/16

(52) U.S. Cl. CPC G06F 1/1622; G06F 1/1624; G06F 1/1681

(57) ABSTRACT

An example computing device includes a hinge, a first housing, a first display device disposed in the first housing, a second housing rotatably coupled to the first housing via the hinge, a second display device disposed in the second housing, and a connector coupled to the first housing and the second display device, where, in response to a rotation of the first housing relative to the second housing, a first end of the second display device is to slide laterally on a surface of the second housing towards the hinge.

### BACKGROUND

A laptop computer is a type of computing device. A laptop computer may have a clamshell configuration where a display device in a first housing and a keyboard in a second housing.

### BRIEF DESCRIPTION OF THE DRAWINGS

Some examples of the present application are described with respect to the following figures:

FIG. 1 illustrates a computing device having a connector to adjust an orientation of an output device, according to an example;

FIG. 2A illustrates a cross-sectional view of an output device of a computing device in an undeployed state, according to an example;

FIGS. 2B-2C illustrate cross-sectional views of the output device transitioning from the undeployed state to a deployed state, according to an example;

FIG. 3 is a perspective view of a connector to adjust an orientation of an output device, according to an example;

FIG. 4 illustrates a computing device having an input device in a concave region of the computing device, according to an example;

FIG. 5 illustrates a computing device having an audio component in a concave region of the computing device, according to an example; and

FIG. 6 illustrates a computing device having an output device in a concave region of the computing device, according to an example.

### DETAILED DESCRIPTION

A laptop computer may include a single display device in one of the laptop computer's housings. To be portable, a display area of the display device (the physical size of the area where images/content may be shown) may range from ten inches to seventeen inches in terms of the length of the diagonal. However, the relatively small display area may reduce the effectiveness of some tasks as a user may have to constantly switch from one window to another.

Examples described herein provide an approach to provide additional display area in a computing device, such as a laptop computer. For example, a computing device may include a hinge, a first housing, a first display device disposed in the first housing, a second housing rotatably coupled to the first housing via the hinge, a second display device disposed in the second housing, and a connector coupled to the first housing and the second display device. In response to a rotation of the first housing relative to the second housing, a first end of the second display device may slide laterally on a surface of the second housing towards the hinge.

In another example, a computing device may include a hinge, a first housing, a first display device disposed in the first housing, a second housing rotatably coupled to the first housing via the hinge. The second housing may include a concave region. The computing device may also include a second display device disposed in the concave region and a connector to link a sliding movement of a first end of the second display device on a surface of the concave region to a rotation of the first housing relative to the second housing. The connector may be coupled to the first housing and the second display device.

In another example, a computing device may include a hinge, a first housing, a display device disposed in the first housing, a second housing rotatably coupled to the first housing via the hinge, an output device disposed in the second housing, an input device disposed in the second housing, and a connector coupled to the first housing and the output device. A rotation of the first housing relative to the second housing may adjust an orientation of the output device via the connector. Examples described herein may increase the available display area in a laptop computer as compared to a laptop computer having a single display device.

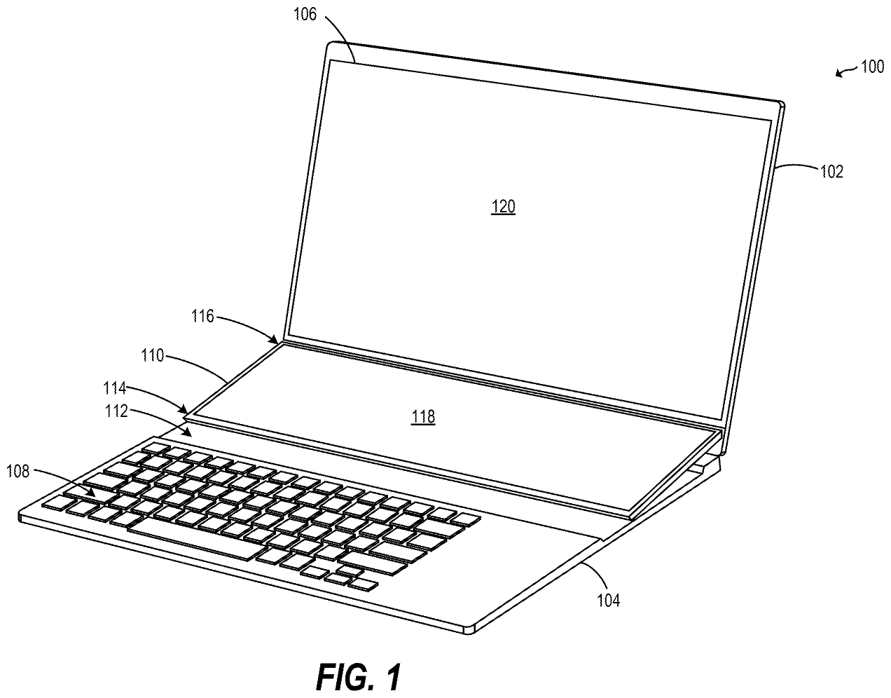

FIG. 1 illustrates a computing device 100 having a connector to adjust an orientation of an output device, according to an example. Computing device 100, for example, may be a laptop computer. Computing device 100 may include a first housing 102 and a second housing 104. Computing device 100 may also include a first display device 106 disposed in first housing 102. Computing device 100 may further include an input device 108. Input device 108 may be a keyboard, touchpad, or any other device that provides data and control command to computing device 100. Computing device 100 may further include a second display device 110. Computing device 100 may further include a concave region 112 in second housing 104. As used herein, a display device, such as first display device 106 and second display device 110, may include a display panel and circuitry to control operations of the display panel (e.g., a controller). The display panel is each display device 106 and 110 may be implemented as a liquid crystal display (LCD) panel, a light-emitting diode (LED) panel, an organic light-emitting diode (OLED) panel, a flexible display panel/film, etc.

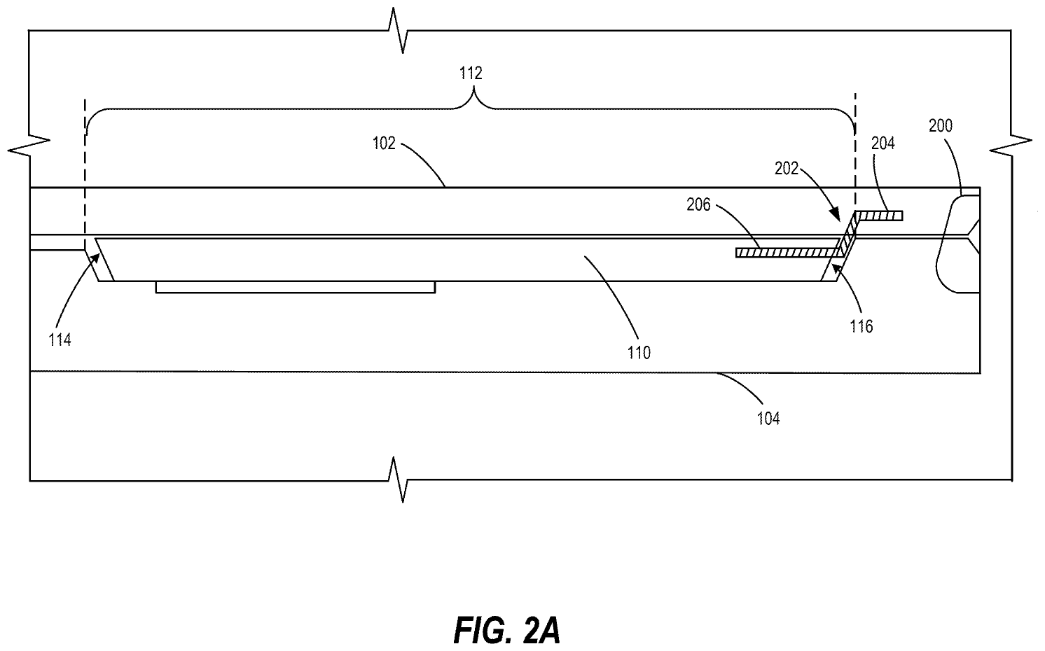

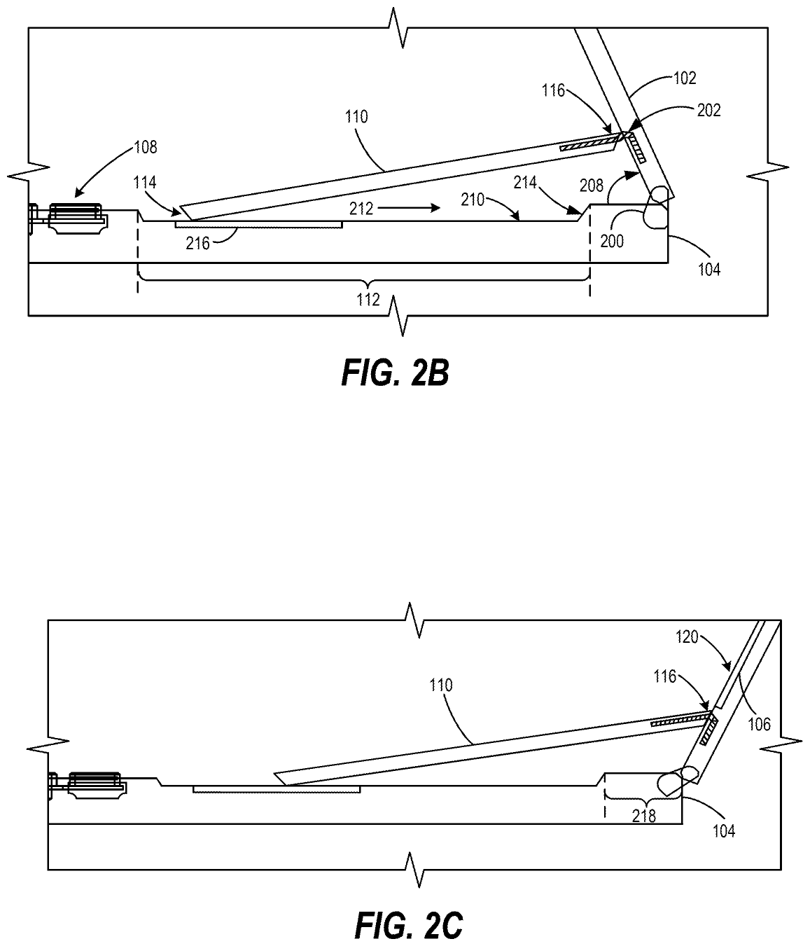

In FIG. 1, second display device 110 may be in a deployed state. Second display device 110 may be in the deployed state when a first end 114 of second display device 110 is disposed in concave region 112 and a second end 116 of second display device 110 is disposed outside of concave region 112. In the deployed state, second display device 110 may be positioned close to the bottom of first display device 106 and titled at a particular angle such that a display area 118 of second display device 110 and a display area 120 of first display device 106 may appear to a user as a continuous display area. As used herein, a display area may be where images/videos are shown on a display device. As described in more detail in FIGS. 2A-2C, second display device 110 may transition from an undeployed state to the deployed state in response to a rotation of first housing 102 relative to second housing 104.

FIG. 2A illustrates an output device of a computing device in an undeployed state, according to an example. As illustrated in FIG. 2A, second display device 110 may be in an undeployed state. When in the undeployed state, both ends 114 and 116 of second display device 110 may be disposed in concave region 112. That is, the entire second display device 110 may be disposed in concave region 112 lengthwise and widthwise.

Second display device 110 may be in the undeployed state when computing device 100 is in a closed configuration, as illustrated in FIG. 2A. Computing device 100 may include a hinge 200 coupled to first housing 102 and second housing 104. Thus, housings 102 and 104 may be rotatably coupled to each other. First housing 102 may rotate relative to second housing 104 via hinge 200. Second housing 104 may rotate relative to first housing 102 via hinge 200. Computing device 100 may also include a connector 202 that is coupled to first housing 102 and second display device 110. Connector 202 may include a first section 204 and a second section 206. First section 204 may be disposed in first housing 102. Second section 206 may be disposed in second display device 110. As described in more detail in FIGS. 2B and 2C, connector 202 may link a sliding movement of first end 114 of second display device 110 on a surface of concave region 112 to a rotation of first housing 102 relative to the second housing 104. Connector 202 may also link a lifting of second end 116 of second display device 110 to the rotation of first housing 102.

Turning to FIG. 2B, when first housing 102 is rotating relative to second housing 104 (the direction of rotation is indicated by an arrow 208), the rotation may lift second end 116 of second display device 110 away from concave region 112. The rotation may also cause first end 114 to slide laterally on a surface 210 of concave region 112 towards hinge 200 (the direction of the slide is indicated by an arrow 212) and away from input device 108. In some examples, concave region 112 may include a sloping region 214 to facilitate the lifting of second end 116. Sloping region 214 may act a ramp for second end 116 to be lift away from concave region 112.

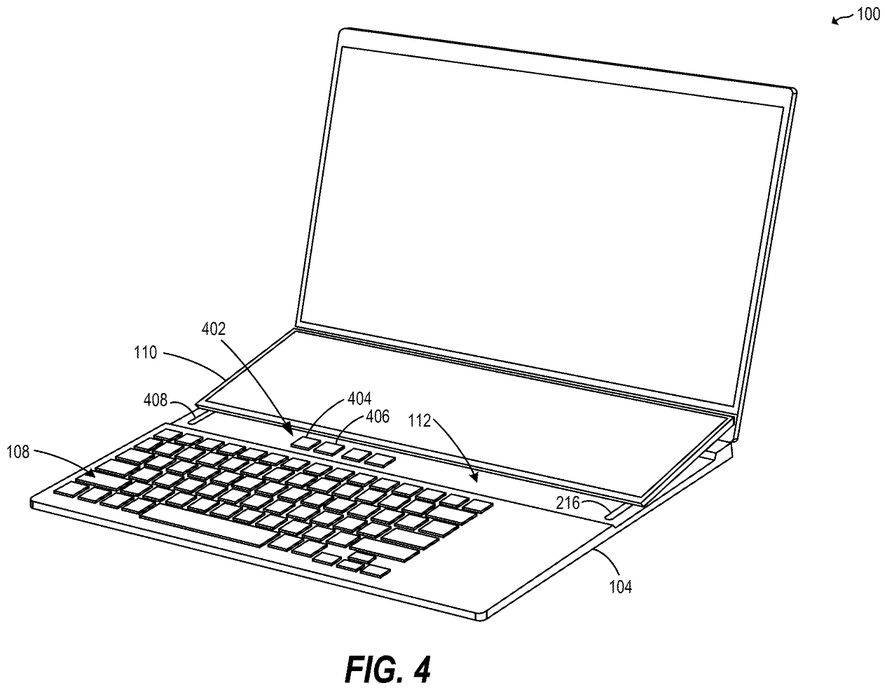

In some examples, a magnetic track 216 may be disposed in second housing 104 and second display device 110 may include a magnetic section, such as the housing of second display device 110. Thus, magnetic track 216 may provide an attracting force to hold a portion of second display device 110, such as first end 114, in contact with surface 210 of second housing 104. The attracting force may enable a smooth sliding movement of second display device 110 when second display device 110 is transitioning from the undeployed state to the deployed state. In some examples, multiple magnetic tracks may be disposed in second housing 104. An example of multiple magnetic tracks is described in more detail in FIG. 4

Turning to FIG. 2C, as illustrated in FIG. 2C, second display device 110 may be at the deployed state. When at the deployed state, second end 116 of second display device 110 may be positioned below display area 120 of first display device 106. When second display device 110 is at the deployed state, second display device 110 may be overlapping with an end region 218 of second housing 104. End region 218 may correspond to a distal end of second housing 104. End region 218 may be located between concave region 112 and hinge 200. When second display device 110 is at the undeployed state, second display device 110 and end region 218 may be nonoverlapping, as illustrated in FIG. 2A.

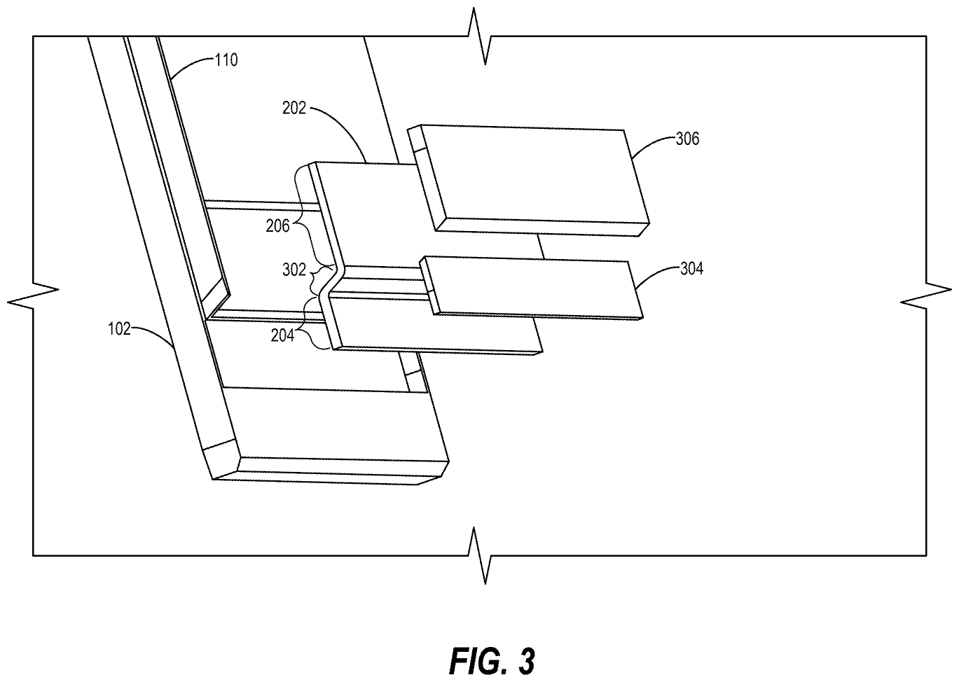

FIG. 3 is a perspective view of connector 202 to adjust an orientation of an output device, according to an example. Connector 202 may include three sections, first section 204, second section 206, and a third section 302. First section 204 may be fixedly disposed in first housing 102 via fasteners (e.g., screws). A cover 304 may be disposed on top of first section 204 so that first section 204 may be concealed from the view of a user. Second section 206 may also be fixedly disposed in second display device 110 via fasteners. A cover 306 may be disposed on top of second section 206 to conceal second section 206 from the view of a user. Connector 202 may be made from flexible material. In some examples, connector 202 may be made from thermoplastic elastomer material, such as thermoplastic polyurethane, thermoplastic copolyester, etc.

In some examples, computing device 100 may include a component that is disposed in concave region 112. The component and second display device 110 may be overlapping when second display device 110 is in the undeployed state. The component and second display device 110 may be nonoverlapping when second display device 110 is in the deployed state. The component may be an input device, an output device, or a structure associated with thermal management of computing device 100. The component may be disposed between magnetic track 216 and a magnetic track 408 within concave region 112. Examples of the component are described in more detail in FIGS. 4-6.

Turning to FIG. 4, the component may be an input device 402. Input device 402 may be separate from input device 108. Input device 402 may be a set of keys. The set of keys may be programmed to provide specialized functions. For example, a key 404 may cause a software application to be executed when pressed. A key 406 may cause a brightness setting of first display device 106 to change when pressed.

When second display device 110 is at the undeployed state, second display device 110 may overlap with input device 402 such that second display device 110 may be disposed on top of input device 402 in concave region 112. Thus, input device 402 may be blocked from view of a user of computing device 100. When second display device 110 is at the deployed state, input device 402 may be unblocked and become visible to the user due to the movement of second display device 110. In some examples, instead of physical keys, a touch sensitive display device may implement input device 402.

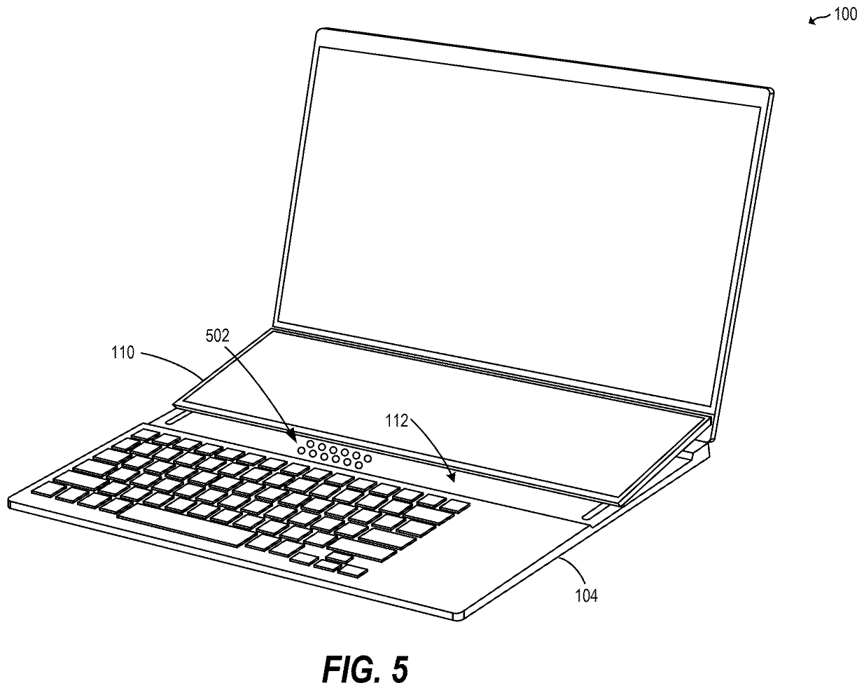

Turning to FIG. 5, the component may be a set of vents 502. Set of vents 502 may enable a cooling fan to expel hot air generated by electronic components (e.g., a processor) of second housing 104 to the outside of second housing 104. Thus, the temperature inside second housing 104 may be lowered.

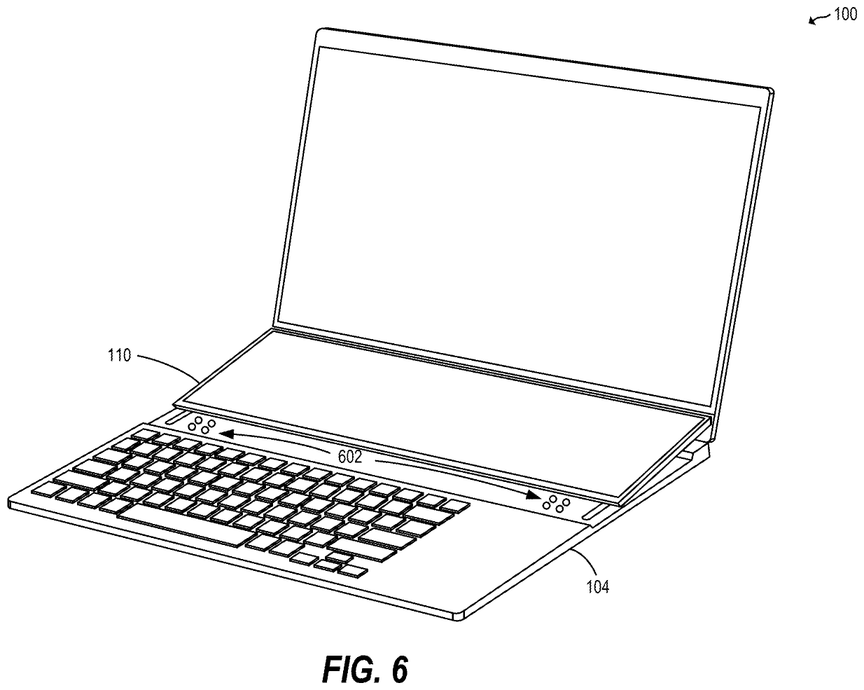

Turning to FIG. 6, the component may be an audio component 602. Audio component 602 may be a set of speakers. Thus, when second display device 110 is at the deployed state, the set of speakers may be unblocked and provide sound output for computing device 100.

The use of “comprising”, “including” or “having” are synonymous and variations thereof herein are meant to be inclusive or open-ended and do not exclude additional unrecited elements or method steps.

What is claimed is:

1. A computing device comprising:
a hinge;
a first housing;
a first display device disposed in the first housing;
a second housing rotatably coupled to the first housing via the hinge;
a second display device disposed in the second housing; and
a connector coupled to the first housing and the second display device, wherein, in response to a rotation of the first housing relative to the second housing, a first end of the second display device is to slide laterally on a surface of the second housing towards the hinge.

2. The computing device of claim 1, further comprising a magnetic track disposed in the second housing, wherein the magnetic track is to provide an attracting force to hold a portion of the second display device in contact with the surface of the second housing.

3. The computing device of claim 1, wherein the connector includes a first section and a second section, wherein the first section is disposed in the first housing, and wherein the second section is disposed in the second display device.

4. The computing device of claim 1, wherein the connector is made from thermoplastic elastomer material.

5. The computing device of claim 1, wherein the second housing further includes an end region, wherein the second display device and the end region are nonoverlapping when the second display device is in an undeployed state, and wherein the second display device and the end region are overlapping when the second display device is in a deployed state.

6. A computing device comprising:
a hinge;
a first housing;
a first display device disposed in the first housing;
a second housing rotatably coupled to the first housing via the hinge, wherein the second housing includes a concave region;
a second display device disposed in the concave region; and
a connector to link a sliding movement of a first end of the second display device on a surface of the concave region to a rotation of the first housing relative to the second housing, wherein the connector is coupled to the first housing and the second display device.

7. The computing device of claim 6, wherein the connector is to link a lifting of a second end of the second display device to the rotation, wherein the concave region includes a sloping region to facilitate the lifting.

8. The computing device of claim 6, wherein the second display device is in an undeployed state when the first end and a second end of the second display device are disposed in the concave region, and wherein the second display device is in a deployed state when the second end is disposed outside of the concave region and the first end is disposed in the concave region.

9. The computing device of claim 8, further comprising:
an audio component disposed in the concave region, wherein the audio component and the second display device are overlapping when the second display device is in the undeployed state, and wherein the audio component and the second display device are nonoverlapping when the second display device is in the deployed state.

10. The computing device of claim 8, further comprising:
an input device disposed in the concave region, wherein the input device and the second display device are overlapping when the second display device is in the undeployed state, and wherein the input device and the second display device are nonoverlapping when the second display device is in the deployed state.

11. The computing device of claim 8, further comprising:
a set of vents disposed in the concave region, wherein the set of vents and the second display device are overlapping when the second display device is in the undeployed state, and wherein the set of vents and the second display device are nonoverlapping when the second display device is in the deployed state.

12. The computing device of claim 8, wherein the second end of the second display device is positioned below a display area of the first display device when the second display device is in the deployed state.

13. A computing device comprising:
a hinge;
a first housing;
a display device disposed in the first housing;
a second housing rotatably coupled to the first housing via the hinge;
an output device disposed in the second housing;
an input device disposed in the second housing; and
a connector coupled to the first housing and the output device, wherein a rotation of the first housing relative to the second housing is to adjust an orientation of the output device via the connector.

14. The computing device of claim 13, wherein the input device is a set of keys, and wherein the output device is a second display device.

15. The computing device of claim 13, wherein the rotation is to lift an end of the output device.
